(19) United States
(12) Patent Application Publication
(10) Pub. No.: US 2026/0239280 A1
(43) Pub. Date: Aug. 13, 2026

(54) NON-TERRESTRIAL NETWORK POSITIONING AND CONFIGURATION

(71) Applicant: LENOVO (SINGAPORE) PTE. LTD., Singapore (SG)

(72) Inventors: Sher Ali Cheema, LLMENAU (DE); Robin Rajan Thomas, Bad Nauheim (DE); Vijay Nangia, Woodridge, IL (US)

(73) Assignee: LENOVO (SINGAPORE) PTE. LTD., Singapore (SG)

(21) Appl. No.: 19/156,598

(22) PCT Filed: Feb. 15, 2024
(86) PCT No.: PCT/IB2024/051437

§ 371 Date: Aug. 14, 2025

Related U.S. Application Data
(60) Provisional application No. 63/485,091, filed on Feb. 15, 2023.

(51) Int. Cl. H04W 64/00; H04L 5/00; H04W 72/044; H04W 84/06

(52) U.S. Cl. CPC H04W 64/00; H04L 5/0048; H04W 72/044; H04W 84/06

(57) ABSTRACT

Various aspects of the present disclosure relate to an apparatus for NTN positioning and configuration. The apparatus, such as a location management function (LMF) (e.g., a network entity) transmits, to a non-terrestrial network (NTN) entity and/or to a user equipment (UE), a first signaling as a request message for configuration parameters enabling one or more positioning methods. The LMF receives a second signaling as a response message with associated satellite information from the NTN entity and/or from the UE. The LMF determines a positioning method based at least in part on the associated satellite information received in the response message, and configures time-frequency positioning reference signal resources for the positioning method based on the associated satellite information.

### RELATED APPLICATION

This application claims priority to U.S. Provisional Application Ser. No. 63/485,091 filed Feb. 15, 2023 entitled “Non-Terrestrial Network Positioning and Configuration,” the disclosure of which is incorporated by reference herein in its entirety.

### TECHNICAL FIELD

The present disclosure relates to wireless communications, and more specifically to a non-terrestrial network (NTN).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, such as an NTN, network verification of a reported location of a UE in the NTN is considered utilizing the typical radio access technology (RAT)-dependent positioning methods in NR Rel-17. The positioning techniques in 3GPP have been developed based on the typical scenarios experienced in terrestrial networks, where measurement results from at least three gNBs are used for location estimates. However, a common scenario in NTN is that a UE may only be within the coverage area of a single satellite, in which case the conventional positioning methods are not adapted for this type of single satellite case. Notably, with only the coverage of a single satellite, only a few positioning methods may be feasible to provide the accuracy threshold needed for network verification for a single satellite case.

### SUMMARY

The present disclosure relates to methods, apparatuses, and systems that support NTN positioning and configuration. By utilizing the described techniques, a location server in an NTN is provided capability support information to select one or more positioning methods and/or to configure appropriate resources for UEs in the NTN. The described techniques include NTN positioning and signaling capabilities between an NG-RAN node (e.g., an NTN entity), a target UE, and the location server (e.g., LMF), with the location server implemented to select an appropriate method for NTN positioning and to configure appropriate resources for wireless communications at a target UE. In one or more implementations, the enhanced support information includes an indication of the number of satellites in view (e.g., within coverage range) of the target UE with an explicit or implicit indication using LTE positioning protocol (LPP), an indication of the number of satellites by NG-RAN using NR positioning protocol annex (NRPPa), an indication of the NG-RAN node and UE support for a polarization type using NRPPa, and/or an indication of UE support for a polarization type using LPP.

In aspects of NTN positioning and configuration, a location server is provided additional information to select a positioning method and/or to configure appropriate resources in an NTN. The described techniques include NTN positioning and signaling capabilities between an NG-RAN node (e.g., an NTN entity), a target UE, and a location server (e.g., location management function (LMF)), with the location server implemented to select an appropriate method for NTN positioning and to configure appropriate resources for wireless communications by the target UE. The network location server (e.g., location management function (LMF)) can utilize the information as to the number of satellites in view (e.g., for coverage) in order to select an appropriate positioning method and to correctly apply the measurement and reporting procedure. Further, in addition to linear polarization in NTN, circular polarization types have been adopted to enhance the link budget. An association of a polarization type with the positioning reference signal (PRS) provides polarization-based configuration and measurements reporting aspects for PRS. However, a polarization type supported by a NG-RAN node and/or by the target UE can also be indicated to the location server.

In some implementations of the method and apparatuses described herein, a network entity (e.g., an LMF) transmits, to an NTN entity, a first signaling as a request message for configuration parameters enabling one or more positioning methods. The LMF receives a second signaling as a response message with associated satellite information from the NTN entity. The LMF determines a positioning method based at least in part on the associated satellite information received in the response message, and configures time-frequency positioning reference signal resources for the positioning method based on the associated satellite information.

Some implementations of the method and apparatuses described herein may further include the request message includes a request for a number of satellites communicatively linked to the NTN entity. The configuration parameters include a list of at least one of cell-identities (IDs), transmission-reception point (TRP)-IDs, or beam-IDs associated with each of the satellites communicatively linked to the NTN entity. The response message of the associated satellite information includes the number of the satellites communicatively linked to the NTN entity and the list of at least one of the cell-IDs, the TRP-IDs, or the beam-IDs associated with each of the satellites. The response message of the associated satellite information includes a mapping of at least one of cell-IDs, TRP-IDs, or beam-IDs for each satellite communicatively linked to the NTN entity. The response message includes an enhanced cell-ID (E-CID) measurement report message. The E-CID measurement report includes the configuration parameters for at least one of a transmission beam and cell layout configuration, earth fixed cells, earth moving cells, a number of satellites communicatively linked to the NTN entity and within coverage range of a target UE, ephemeris information of the satellites, a list of TRP-IDs and relation to each of the satellites, or a list of cell-IDs and the relation to each of the satellites. The response message includes an indication of a polarization type that is supported by the NTN entity. The response message includes one or more polarization types supported by each of one or more TRPs hosted by the NTN entity. The LMF transmits, to the NTN entity, a third signaling as a configuration of a polarization type for a sounding reference signal (SRS) for reception and transmission.

In some implementations of the method and apparatuses described herein, a network entity (e.g., an LMF) transmits, to a UE, a first signaling as a request message for configuration parameters enabling one or more positioning methods. The LMF receives a second signaling as a response message with associated satellite information from the UE. The LMF determines a positioning method based at least in part on the associated satellite information received in the response message, and configures time-frequency positioning reference signal resources for the positioning method based on the associated satellite information.

Some implementations of the method and apparatuses described herein may further include the request message includes a request for a number of satellites within coverage range of the UE. The request message is a LPP provide capability message. The response message includes an indication of a number of satellites within coverage range of the UE. The number of the satellites within coverage range of the UE are associated with at least one of detected cell-IDs, TRP-IDs, or beam-IDs. The LMF receives a third signaling as an indication to report a number of satellites within coverage range of the UE in at least one of a periodic manner, a semi-persistent manner, or an aperiodic manner. The LMF receives a third signaling as a new response message generated by the UE responsive to a change in a number of satellites within coverage range of the UE. The response message includes an indication of a polarization type that is supported by the UE. The response message includes one or more polarization types supported for downlink reference signals and uplink reference signals.

In some implementations of the method and apparatuses described herein, an NTN entity (e.g., an NG-RAN node) receives, from a network entity, a first signaling as a request message for configuration parameters enabling one or more positioning methods. The NG-RAN node transmits a second signaling as a response message with associated satellite information to the network entity, a positioning method being determinable based at least in part on the associated satellite information and time-frequency positioning reference signal resources being configurable for the positioning method.

Some implementations of the method and apparatuses described herein may further include the request message includes a request for a number of satellites communicatively linked to the apparatus. The configuration parameters include a list of at least one of cell-IDs, TRP-IDs, or beam-IDs associated with each of the satellites communicatively linked to the apparatus. The response message of the associated satellite information includes the number of the satellites communicatively linked to the apparatus and the list of at least one of the cell-IDs, the TRP-IDs, or the beam-IDs associated with each of the satellites. The response message of the associated satellite information includes a mapping of at least one of cell-IDs, TRP-IDs, or beam-IDs for each satellite communicatively linked to the apparatus. The response message includes an E-CID measurement report message. The E-CID measurement report includes the configuration parameters for at least one of a transmission beam and cell layout configuration, earth fixed cells, earth moving cells, a number of satellites communicatively linked to the apparatus and within coverage range of a target UE, ephemeris information of the satellites, a list of TRP-IDs and relation to each of the satellites, or a list of cell-IDs and the relation to each of the satellites. The response message includes an indication of a polarization type that is supported by the apparatus. The response message includes one or more polarization types supported by each of one or more TRPs hosted by the apparatus. The NG-RAN node receives, from the network entity, a third signaling as a configuration of a polarization type for a SRS for reception and transmission.

In some implementations of the method and apparatuses described herein, a UE receives, from a network entity, a first signaling as a request message for configuration parameters enabling one or more positioning methods, the request message including a request for a number of satellites within coverage range of the apparatus. The UE transmits a second signaling as a response message with associated satellite information to the network entity, a positioning method being determinable based at least in part on the associated satellite information and time-frequency positioning reference signal resources being configurable for the positioning method.

Some implementations of the method and apparatuses described herein may further include the request message is a LPP provide capability message. The response message includes an indication of the number of the satellites within coverage range of the apparatus. The number of the satellites within coverage range of the apparatus are associated with at least one of detected cell-IDs, TRP-IDs, or beam-IDs. The UE transmits a third signaling as a report of the number of the satellites within coverage range of the apparatus in at least one of a periodic manner, a semi-persistent manner, or an aperiodic manner. The UE transmits a third signaling as a new response message generated by the apparatus responsive to a change in the number of the satellites within coverage range of the apparatus. The response message includes an indication of a polarization type that is supported by the apparatus. The response message includes one or more polarization types supported for downlink reference signals and uplink reference signals.

### BRIEF DESCRIPTION OF THE DRAWINGS

FIG. 1 illustrates an example of a wireless communications system that supports NTN positioning and configuration in accordance with aspects of the present disclosure.

FIG. 2 illustrates an example of a system for NR DL-based positioning, as related to NTN positioning and configuration in accordance with aspects of the present disclosure.

FIG. 3 illustrates an example of DL-TDOA assistance data configuration, as related to NTN positioning and configuration in accordance with aspects of the present disclosure.

FIG. 4 illustrates an example of a DL-TDOA measurement report configuration, as related to NTN positioning and configuration in accordance with aspects of the present disclosure.

FIG. 5 illustrates an example of a UE positioning overall architecture applicable to NG-RAN, as related to NTN positioning and configuration in accordance with aspects of the present disclosure.

FIG. 6 illustrates an example of location service support by NG-RAN in sequence of signaling events, as related to NTN positioning and configuration in accordance with aspects of the present disclosure.

FIG. 7 illustrates an example of a NG-RAN location reporting procedure, as related to NTN positioning and configuration in accordance with aspects of the present disclosure.

FIG. 8 illustrates an example of a networking-RAN architecture with transparent satellite, as related to NTN positioning and configuration in accordance with aspects of the present disclosure.

FIG. 9 illustrates an example of a regenerative satellite without ISL and gNB processed payload, as related to NTN positioning and configuration in accordance with aspects of the present disclosure.

FIG. 10 illustrates an example of a regenerative satellite with ISL and gNB processed payload, as related to NTN positioning and configuration in accordance with aspects of the present disclosure.

FIGS. 11 and 12 illustrate an example of a block diagram of devices that supports NTN positioning and configuration in accordance with aspects of the present disclosure.

FIGS. 13-20 illustrate flowcharts of methods that support NTN positioning and configuration in accordance with aspects of the present disclosure.

### DETAILED DESCRIPTION

A wireless communications system, such as an NTN, may support various network devices and/or entities for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances. In a positioning system for an NTN, one or more location servers, or components of the location servers, may communicate with one or multiple UEs connected to the NTN over a wireless medium.

In current implementations, network verification of a reported location of a UE in an NTN utilizes the typical RAT-dependent positioning methods. The positioning techniques in 3GPP have been developed based on the typical scenarios experienced in terrestrial networks, where measurement results from at least three gNBs are used for location estimates. However, a common scenario in NTN is that a UE may only be within the coverage area of a single satellite, in which case the conventional positioning methods are not adapted for this type of single satellite case. Notably, with only the coverage of a single satellite, only a few positioning methods may be feasible to provide the accuracy threshold needed for network verification for a single satellite case. Some current positioning methods may be explicitly used for a single satellite scenario, while some other positioning methods may be used for both single and multiple satellites. Further, in an NTN, multiple polarization types have been adopted, where supporting one or multiple polarization types may depend on the network or device capability to support a polarization type.

In aspects of NTN positioning and configuration, a location server is provided additional information to select a positioning method and/or to configure appropriate resources in an NTN. The described techniques include NTN positioning and signaling capabilities between an NG-RAN node (e.g., an NTN entity), a target UE, and a location server (e.g., LMF), with the location server implemented to select an appropriate method for NTN positioning and to configure appropriate resources for wireless communications with the target UE.

For location verification in NTN, some positioning methods may only be applicable for target UEs that are in view (e.g., within coverage range) of a single satellite (e.g., multi-round trip time (RTT)), while some methods may only be applicable when a target UE has at least three satellites in view (e.g., downlink time difference of arrival (DL-TDOA)). In many cases, one NG-RAN node may be communicatively linked to multiple satellites that may or may not provide coverage to the same UE, thus relying on only NG-RAN information may not be sufficient. Therefore, the network location server (e.g., location management function (LMF)) needs the information as to the number of satellites in view (e.g., for coverage) in order to select an appropriate positioning method and to correctly apply the measurement and reporting procedure. Further, in addition to linear polarization in NTN, circular polarization types have been adopted to enhance the link budget. An association of a polarization type with the positioning reference signal (PRS) provides polarization-based configuration and measurements reporting aspects for PRS. However, a polarization type supported by a NG-RAN node and/or by the target UE can also be indicated to the location server.

Aspects of the present disclosure are described in the context of a wireless communications system. Aspects of the present disclosure are further illustrated and described with reference to device diagrams and flowcharts.

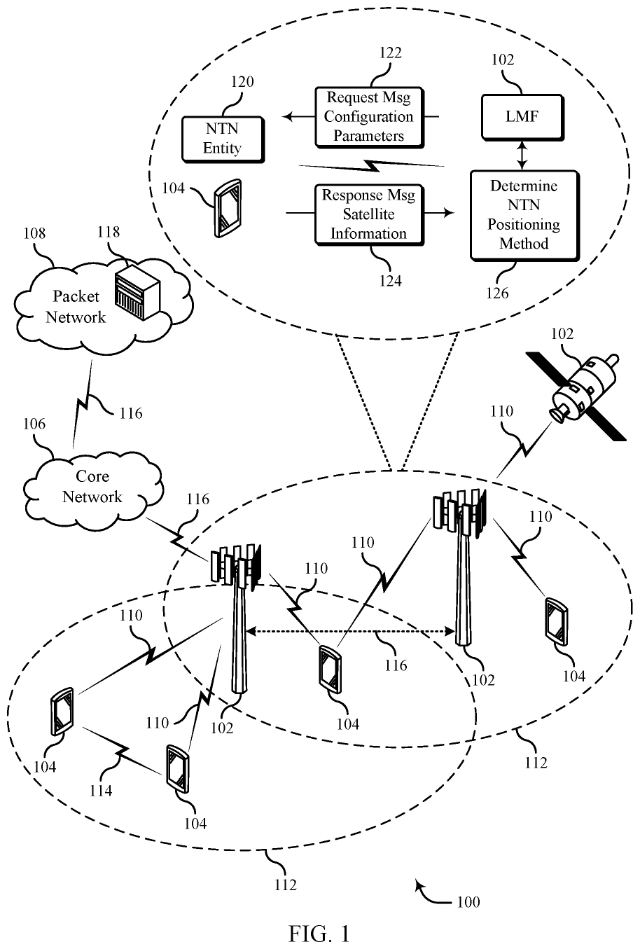

FIG. 1 illustrates an example of a wireless communications system 100 that supports NTN positioning and configuration in accordance with aspects of the present disclosure. The wireless communications system 100 may include one or more network entities (NE) 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a TRP. One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of NTN positioning and configuration, as described herein. For instance, an LMF (e.g., a network entity 102) transmits, to an NTN entity 120 (e.g., a NG-RAN node) and/or to a UE 104, a signaling as a request message 122 for configuration parameters enabling one or more positioning methods. In response, the LMF receives a signaling as a response message 124 with associated satellite information from the NTN entity 120, and/or receives a response message with associated satellite information from the UE 104. The LMF then determines a positioning method 126 based at least in part on the associated satellite information received in the response message, and configures time-frequency positioning reference signal resources for the positioning method based on the associated satellite information.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIoT |
|---|---|---|
| Horizontal Positioning | (<1 m) for 90% | (<0.2 m) for 90% of UEs; |
| | of UEs | |
| Vertical Positioning | (<3 m) for 90% | (<1 m) for 90% of UEs |
| | of UEs | |
| Physical layer latency for | (<10 ms) | (<10 ms) |
| position estimation of UE | | |
| End-to-End Latency for | (<100 ms) | K 100 ms, in the order of |
| position estimation of UE | | 10 ms is desired) |

The supported positioning techniques in Release 16 are listed in Table 1.

TABLE T1
Supported Rel-16 UE Positioning Methods

| | | UE-assisted, | NG-RAN | |
|---|---|---|---|---|
| Method | UE-based | LMF-based | node assisted | SUPL |
| A-GNSS | Yes | Yes | No | Yes (UE-based and UE-assisted) |
| OTDOA ^{Notes1, 2} | No | Yes | No | Yes (UE-assisted) |
| E-CID ^{Note 4} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AOD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}
This includes TBS positioning based on PRS signals.
^{NOTE 2}
In this version of the specification only observed time different of arrival (OTDOA) based on LTE signals is supported.
^{NOTE 4}
This includes Cell-ID for NR method.
^{NOTE 5}
In this version of the specification only for TBS positioning based on Metropolitan Beacon System (MBS) signals.

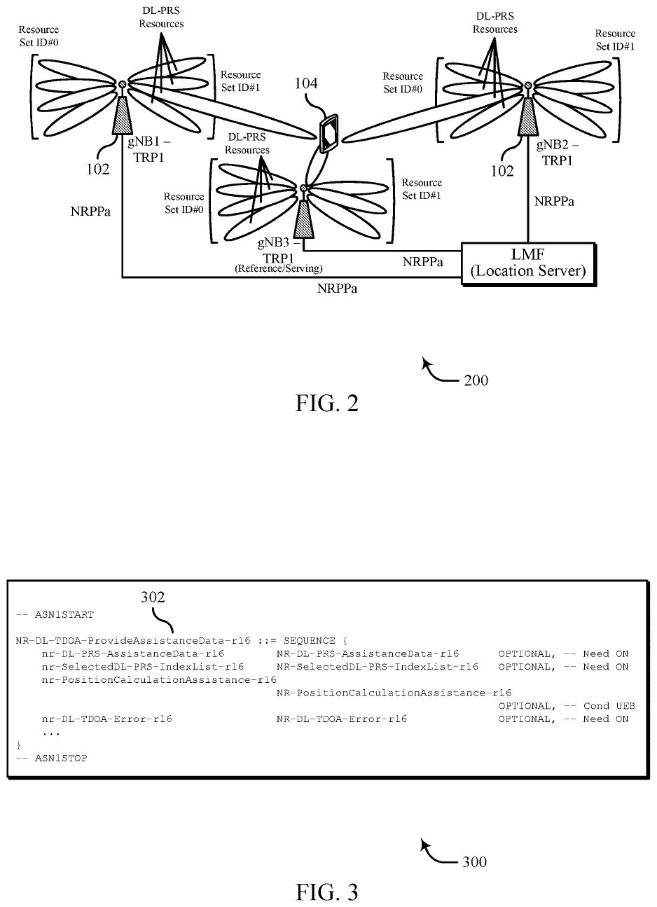

Separate positioning techniques as indicated in Table 1 can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per TRP, where a TRP may include a set of one or more beams. A conceptual overview is illustrated in FIG. 2.

Various RAT-dependent positioning techniques are supported in Release 16 and Release 17, such as DL-TDoA, DL-AOD, Multi-RTT, E-CID/NR E-CID, UL-TDoA, and UL-AoA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs. The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

For the NR E-CID positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR E-CID positioning refers to techniques which use additional UE measurements and/or NR radio resources and other measurements to improve the UE location estimate using NR signals. Although E-CID positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation. Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

FIG. 2 illustrates an example of a system 200 for NR DL-based positioning, as related to NTN positioning and configuration in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as RSTD and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location.

Tables 2 and 3 show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, wireless local area network (WLAN), and Bluetooth technologies for performing target device (UE) positioning.

TABLE 2
UE measurements to enable RAT-
dependent positioning techniques.

| | | To facilitate |
|---|---|---|
| | | support of the |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, DL- |
| | | AoD, Multi-RTT |
| Rel. 16 DL PRS/Rel. 16 | UE Rx-Tx time difference | Multi-RTT |
| SRS for positioning | | |
| Rel. 15 SSB/CSI-RS | SS-RSRP(RSRP for RRM), | NR E-CID |
| for RRM | SS-RSRQ(for RRM), | |
| | CSI-RSRP (for RRM), | |
| | CSI-RSRQ (for RRM), | |
| | SS-RSRPB (for RRM) | |

TABLE 3
gNB measurements to enable RAT-dependent
positioning techniques.

| | | To facilitate support |
|---|---|---|
| DL/UL Reference | | of the positioning |
| Signals | gNB Measurements | techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel. 16 SRS for | gNB Rx-Tx time | Multi-RTT |
| positioning, Rel. 16 | difference | |
| DL PRS | | |
| Rel. 16 SRS for | AoA and ZoA | UL-AoA, Multi-RTT |
| positioning | | |

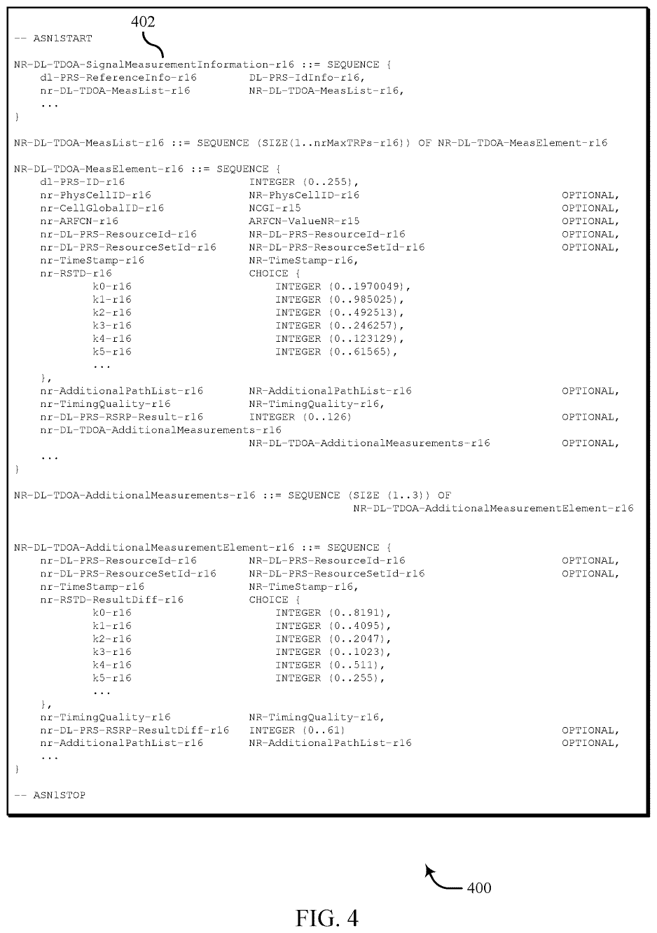

FIG. 3 illustrates an example 300 of a DL-TDOA assistance data configuration, as related to DL-based positioning techniques and NTN positioning and configuration in accordance with aspects of the present disclosure. In the DL-TDOA assistance data, the information element (IE) NR-DL-TDOA-ProvideAssistanceData 302 is used by the location server to provide assistance data to enable UE-assisted and UE-based NR DL-TDOA, and may also be used to provide a NR DL-TDOA positioning specific error reason.

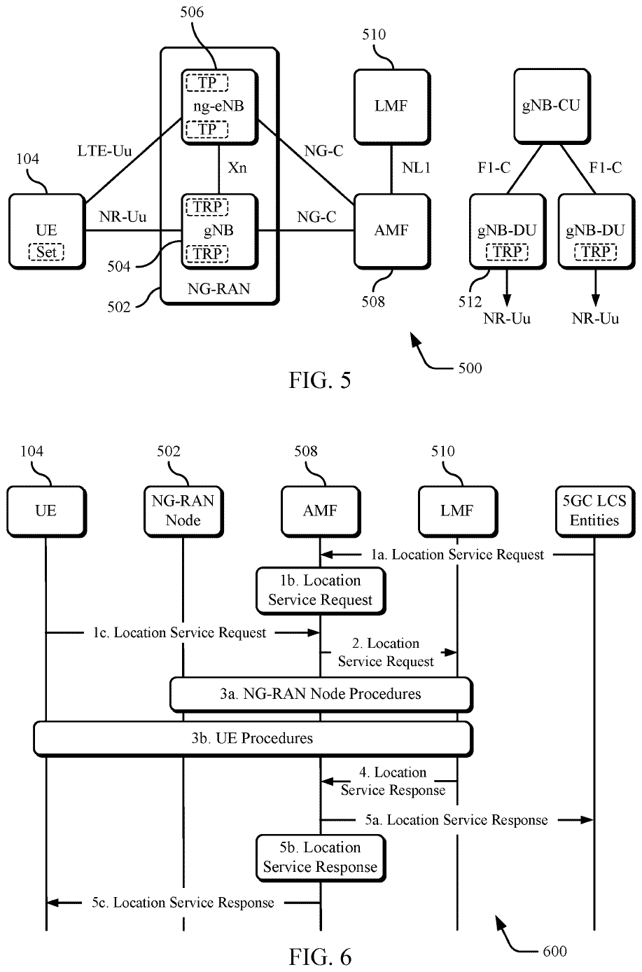

FIG. 4 illustrates an example 400 of a DL-TDOA measurement report configuration, as related to NTN positioning and configuration in accordance with aspects of the present disclosure. In the DL-TDOA measurement report, the information element (IE) NR-DL-TDOA-SignalMeasurementInformation 402 is used by the target UE to provide NR DL-TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target UE selects a reference resource per the TRP, and compiles the measurements per the TRP based on the selected reference resource.

With reference to RAT-dependent positioning measurements, the different downlink measurements, including DL PRS RSRP, downlink RSTD, and UE Rx-Tx time difference required for the supported RAT-dependent positioning techniques are shown in Table 4. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) (DL PRS-RSRP) measurements can be performed on different downlink PRS resources from the same cell.

TABLE 4
Downlink measurements for downlink-based positioning techniques.
DL PRS reference signal received power (DL PRS-RSRP)

| | |
|---|---|
| Definition | DL PRS RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx-Tx time difference

| | |
|---|---|
| Definition | The UE Rx-Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

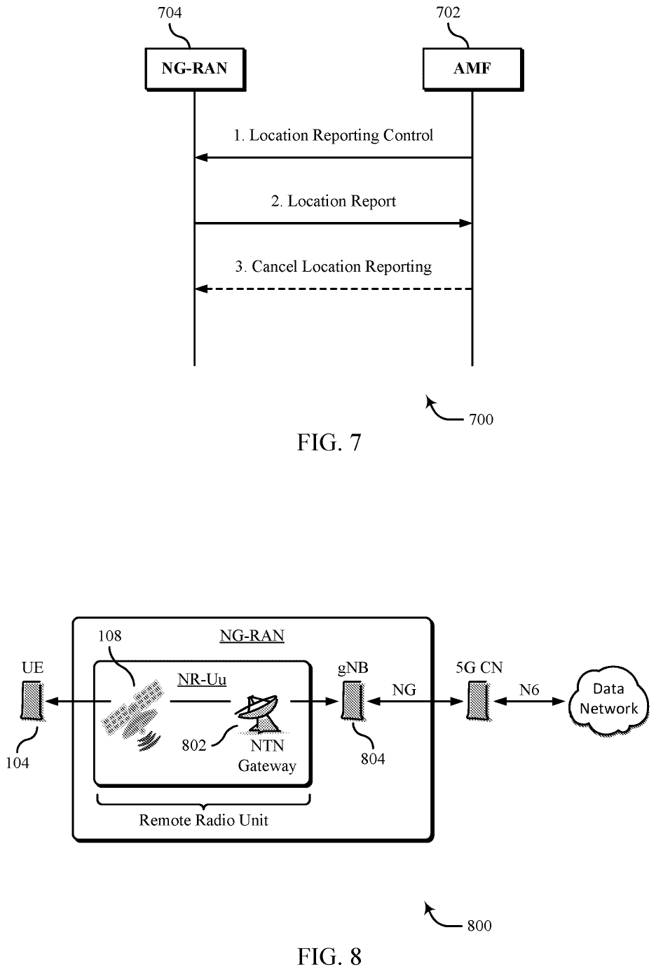

FIG. 5 illustrates an example architecture 500 applicable to NG-RAN 502 for UE positioning. The NG-RAN 502 is capable of supporting both types of interfaces LTE-Uu and NR-Uu, and the gNB 504 may be implemented in an NTN architecture. The gNB 504 and an LTE next generation evolved NodeB (ng-eNB) 506 are connected by a Xn backhaul interface. The access and mobility management function (AMF) 508 may be transparent, or bypassed in an NTN architecture, and the LMF 510 provides the positioning techniques and configuration for UE positioning.

The AMF 508 receives a request for some location service associated with a particular target UE 104 from another entity (e.g., a gateway mobile location center (GMLC) or UE), or the AMF itself decides to initiate some location service on behalf of a particular target UE, such as for an IP multimedia subsystem (IMS) emergency call from the UE. The AMF 508 then sends a location services request to the LMF 510. The LMF 510 processes the location services request which may include transferring assistance data to the target UE 104 to assist with UE-based and/or UE-assisted positioning and/or may include positioning of the target UE. The LMF 510 then returns the result of the location service back to the AMF 508 (e.g., a position estimate for the UE 104). In the case of a location service requested by an entity other than the AMF (e.g., requested by a GMLC or UE), the AMF 508 returns the location service result to this entity.

An NG-RAN node may control several TRPs and/or TPs, such as remote radio heads, or downlink PRS-only TPs for support of PRS-based terrestrial beacon system (TBS). A LMF 510 may have a proprietary signaling connection to an enhanced serving mobile location center (E-SMLC), which may enable the LMF 510 to access information from an evolved universal terrestrial radio access network (E-UTRAN) (e.g. to support the observed time difference of arrival (OTDOA) for a E-UTRA positioning method using downlink measurements obtained by a target UE of signals from next generation evolved NodeBs (ng-eNBs) and/or PRS-only TPs in E-UTRAN). The LMF 510 may have a proprietary signaling connection to a SUPL location platform (SLP). The SUPL location platform (SLP) is the secure user plane location (SUPL) entity responsible for positioning over the user plane. In the case of a split gNB architecture, a gNB-DU 512 may include TRP functionality, where the TRP functionality may support functions for a TP, RP, or both. A gNB-DU 512 that includes TRP functionality does not need to offer cell services. To support positioning of a target UE and delivery of location assistance data to a UE with NG-RAN access in 5GS, location related functions are distributed as described below and shown in the example sequence.

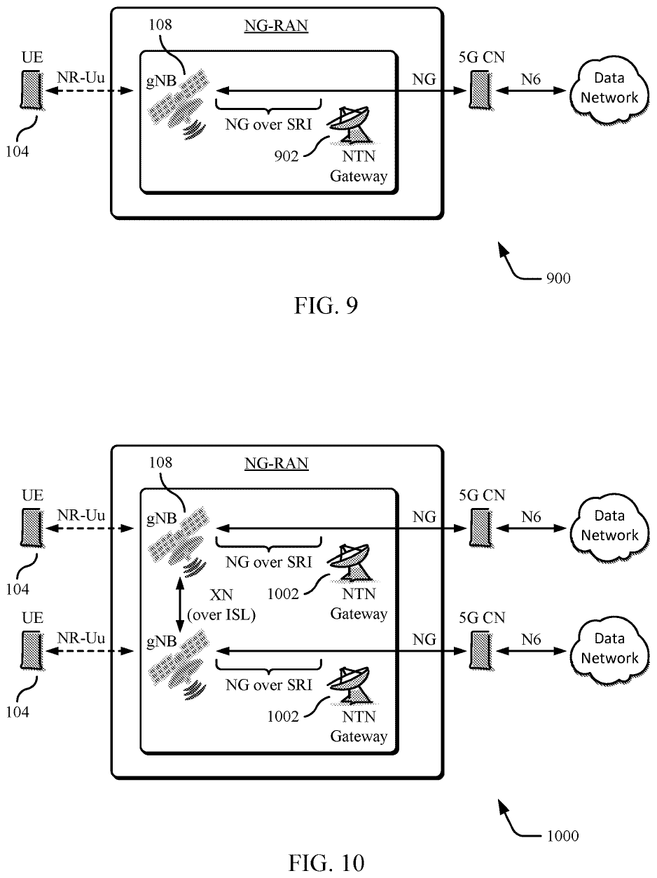

FIG. 6 illustrates an example 600 of location service support by NG-RAN as an overall sequence of signaling events applicable to the UE 104, the NG-RAN 502, the AMF 508, and the LMF 510 for any location service. When the AMF 508 receives a location service request (LSR), and the UE 104 is in a connection management (CM)-idle state (CM-IDLE) state, the AMF 508 performs a network triggered service request in order to establish a signaling connection with the UE and assigns a specific serving gNB or next generation evolved NodeB (ng-eNB). The UE is assumed to be in a connected mode before the beginning of the signaling shown in the figure (i.e., signaling that may be needed to bring the UE to the connected mode prior to step 1a is not shown). However, the signaling connection may be later released, such as by the NG-RAN 502 node as a result of signaling and data inactivity while positioning is still ongoing. Additionally, the NG-RAN 502 node represents any combination of NTSs in an NTN, including a network architecture with a TN and NTN gNB, and/or a network architecture that is fully an NTN with NG-RAN architecture.

At step 1, either step 1a, step 1b, or step 1c is performed. At step 1a, an entity in the 5GC, such as a GMLC, requests a location service for positioning a target UE 104 to the serving AMF 508. Alternatively at step 1b, the serving AMF 508 for the target UE 104 determines the need for a location service (e.g. to locate the UE for an emergency call). Alternatively at step 1c, the UE 104 requests a location service, such as for the positioning or delivery of assistance data, to the serving AMF 508 at the non-access-stratum (NAS) level.

At step 2, the AMF 508 transfers the location service request to the LMF 510. At step 3a, the LMF 510 instigates location procedures with the serving and possibly neighboring next generation evolved NodeB (ng-eNB) or gNB in the NG-RAN 502, such as to obtain positioning measurements or assistance data. In addition to step 3a or alternatively (instead of step 3a), at step 3b, the LMF 510 instigates location procedures with the UE 104, such as to obtain a location estimate or positioning measurements, or to transfer location assistance data to the UE.

At step 4, the LMF 510 provides a location service response to the AMF 508 and includes any needed results, such as a success or failure indication and, if requested and obtained, a location estimate for the UE 104. At step 5a (if step 1a was performed), the AMF 508 returns a location service response to the 5GC entity in step 1a and includes any needed results, such as a location estimate for the UE 104. At step 5b (if step 1b occurred), the AMF 508 uses the location service response received in step 4 to assist the service that triggered this in step 1b, such as to provide a location estimate associated with an emergency call to a GMLC. At step 5c (if step 1c was performed), the AMF 508 returns a location service response to the UE 104 and includes any needed results, such as a location estimate for the UE.

In aspects of signal isolation using polarization in an NTN, the location procedures applicable to NG-RAN occur in steps 3a and 3b, which supports the configurations and reporting for communication between the LMF 510 and the UE 104 to enable an NTN level positioning. The steps 3a and 3b may involve the use of different positioning methods (also referred to herein as positioning techniques or positioning procedures) to obtain location related measurements for a target UE, and from these, the UE computes a location estimate and additional positioning assistance information.

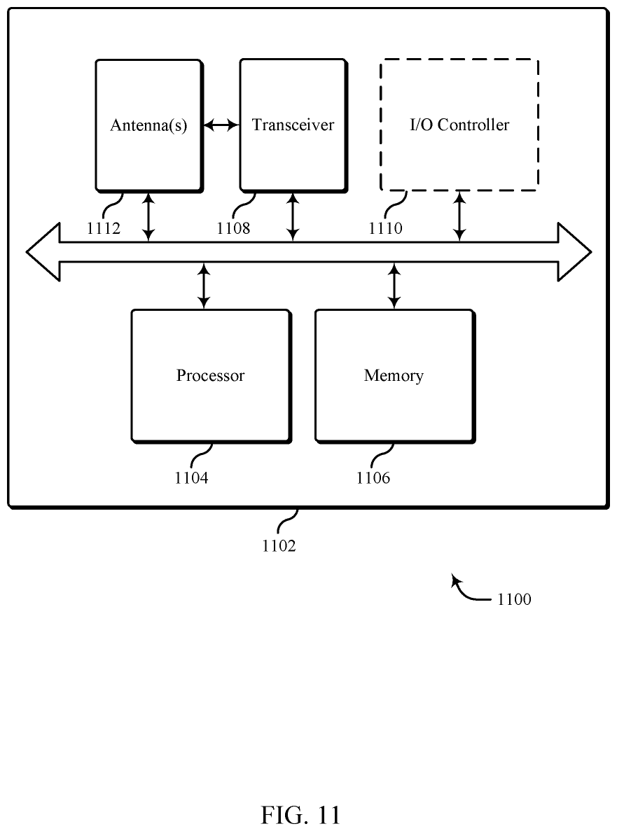

FIG. 7 illustrates an example a NG-RAN location reporting procedure 700, as related to NTN positioning and configuration in accordance with aspects of the present disclosure. This example procedure 700 is used by an access and mobility management function (AMF) 702 to request the NG-RAN 704 to report where the UE is currently located when the target UE is in CM-CONNECTED state. The need for the NG-RAN to continue reporting ceases when the UE transitions to CM-IDLE or when the AMF sends a cancel indication to NG-RAN. This procedure can be used for services that require accurate cell identification (e.g., emergency services, lawful intercept, charging), or for subscription to the service by other NFs. When dual connectivity is activated, PSCell information is only reported if requested by the AMF.

With reference to step (1) AMF to NG-RAN: location reporting control (reporting type, location reporting level, (area of interest, request reference ID)). The AMF sends a location reporting control message to the NG-RAN. The location reporting control message identifies the UE for which reports are requested and includes reporting type and location reporting level. The location reporting control message may also include area of interest and a request reference ID. The location reporting level can be TAI+ cell identity. The reporting type indicates whether the message is intended to trigger a single standalone report about the current cell identity serving the UE, start the NG-RAN to report whenever the UE changes cell, or request the NG-RAN to report whenever the UE moves out or into the area of interest. If the reporting type indicates to report whenever the UE changes cell and if PSCell reporting is requested and dual connectivity is in use, the master RAN node shall also report to the AMF whenever the PSCell changes.

If the reporting type indicates to start the NG-RAN to report when the UE moves out of or into the area of interest, the AMF also provides the requested area of interest information in the location reporting control message. The AMF may include a request reference ID in the location report control message to identify the request of reporting for an area of interest. If multiple areas of interest are included in the message, the request reference ID identifies each area of interest. Requesting reports whenever the UE changes cell can increase the signaling load on multiple interfaces. Requesting reports for all changes in PSCell ID can further increase the signaling load. Accordingly, it is recommended that any such reporting is only applied for a limited number of subscribers.

With reference to step (2) NG-RAN to AMF: location report (UE location, UE presence in area of interest, request reference ID, timestamp). The NG-RAN sends a location report message informing the AMF about the location of the UE which shall be represented as the requested location reporting level. If PSCell reporting is requested and dual connectivity is activated, then the master NG-RAN node shall also include the PSCell ID. With NR satellite access, cell and TAI reporting by NG-RAN refer to a fixed cell and fixed TA in which a UE is geographically located. As part of the user location information, NG-RAN also reports one or more TACs for the selected PLMN, but it is not guaranteed that the UE is always located in one of these TACs.

When the UE is in CM-CONNECTED with RRC inactive state, if NG-RAN has received a location reporting control message from the AMF with the reporting type indicating a single stand-alone report, the NG-RAN shall perform NG-RAN paging before reporting the location to the AMF. The NG-RAN should send the location report promptly and shall not wait to attempt to create a dual connectivity configuration. However, if PSCell reporting is requested and the PSCell ID is known to the master RAN node, then it shall be included in the location report. In the case of RAN paging failure, the RAN reports UE's last known location with a time stamp.

When the UE is in CM-CONNECTED with RRC inactive state, if NG-RAN has received a location reporting control message from the AMF with the reporting type indicating continuous reporting whenever the UE changes cell, the NG-RAN shall send a location report message to the AMF including the UE's last known location with a time stamp. If the UE was using dual connectivity immediately before entering CM-CONNECTED with RRC inactive state and PSCell reporting is requested, then the location report shall also include the PSCell ID.

When the UE is in a CM-CONNECTED, if NG-RAN has received a location reporting control message from the AMF with the reporting type of the area of interest based reporting, the NG-RAN shall track the UE presence in the area of interest and send a location report message to the AMF, including the UE presence in the area of interest (i.e. IN, OUT, or UNKNOWN) as described in clause D.2 and the UE's current location (including the PSCell ID if PSCell reporting is requested and dual connectivity is activated) when the UE is in RRC connected state, or when the UE is in RRC inactive state, the UE's last known location (including the PSCell ID if PSCell reporting is requested and the UE was using dual connectivity immediately before entering CM-CONNECTED with RRC inactive state) with a time stamp if the NG-RAN determines that the UE presence in the area of interest is different from the last one reported. When the NG-RAN detects that the UE has moved out of or into multiple areas of interest, it sends multiple pairs of UE presence in the area of interest and the request reference ID in one location report message to the AMF. If the UE transitions from RRC inactive state to RRC connected state, NG-RAN shall check the latest location (including the PSCell ID if PSCell reporting is requested and dual connectivity is activated) of the UE and follow the rules when the UE is RRC connected. The AMF may receive a location report even if the UE presence in the area of interest is not changed. The AMF stores the latest received PSCell ID with its associated timestamp, when available.

With reference to step (3) AMF to NG-RAN: cancel location report (reporting type, request reference ID). The AMF can send a cancel location reporting message to inform the NG-RAN that it should terminate the location reporting for a given UE corresponding to the reporting type or the location reporting for the area of interest indicated by the request reference ID. This message is needed when the reporting type was requested for continuously reporting or for the area of interest. The AMF may include the request reference ID which indicates the requested location reporting control for the area of interest, so that the NG-RAN should terminate the location reporting for the area of interest. Note that the location reporting related information of the source NG-RAN node is transferred to the target NG-RAN node during Xn handover.

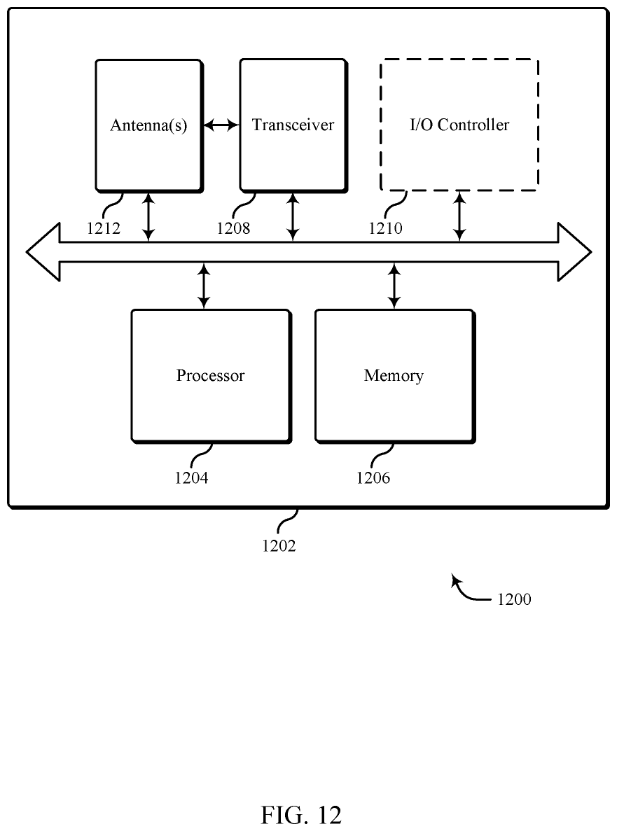

FIG. 8 illustrates an example of a networking-RAN architecture 800 with transparent satellite, as related to NTN positioning and configuration described herein. The satellite payload implements frequency conversion and a radio frequency amplifier in both the uplink and downlink directions, and it corresponds to an analogue RF repeater. Hence, the satellite (e.g., a NTS) repeats the NR-Uu radio interface from the feeder link, between the NTN gateway 802 and the satellite, to the service link between the satellite and the UE 104 (and vice-versa). The satellite radio interface (SRI) on the feeder link is the NR-Uu, meaning that the satellite does not terminate the NR-Uu radio interface. The NTN gateway 802 may support all of the necessary functions to forward the signal of the NR-Uu interface, and different transparent satellites may be connected to the same gNB 804 on the ground. Note that while several gNBs may access a single satellite payload, the illustration and description is simplified to the one gNB 804 accessing the satellite payload, without loss of generality.

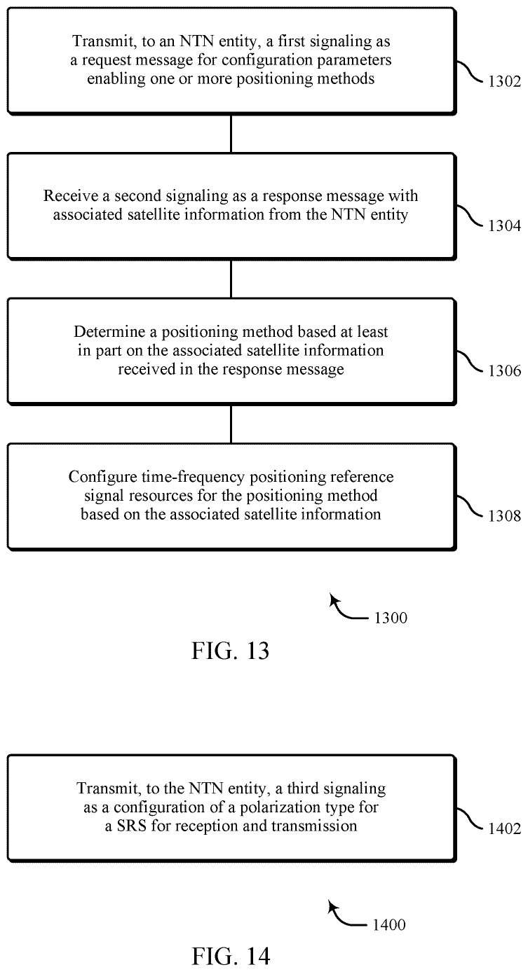

FIG. 9 illustrates an example of a regenerative satellite-based NG-RAN architecture 900, such as a regenerative satellite without an inter-satellite link (ISL) and with a gNB-processed payload. The NG-RAN logical architecture may be used as baseline for an NTN. The satellite payload implements regeneration of the signals received from ground-based network nodes. In this architecture 900, the NR-Uu radio interface is implemented on the service link between the UE 104 and the satellite (e.g., a NTS), and the satellite radio interface (SRI) is implemented on the feeder link between the NTN gateway 902 and the satellite. The satellite radio interface (SRI) is a transport link between the NTN gateway 902 and the satellite.

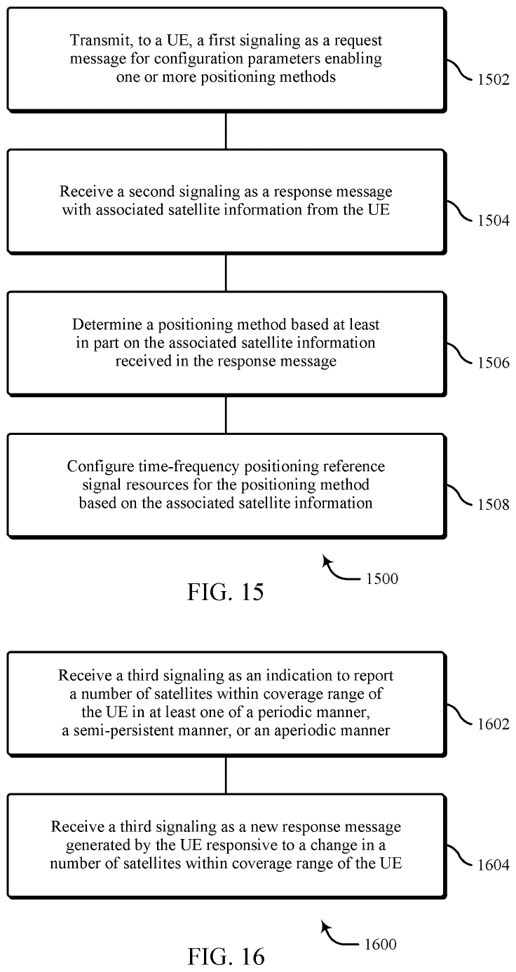

FIG. 10 illustrates another example of a regenerative satellite-based NG-RAN architecture 1000, such as a regenerative satellite system with an inter-satellite link (ISL) and gNB processed payload. The inter-satellite link (ISL) is a transport link, such as a radio interface or an optical interface, between satellites (e.g., NTSs). The NTN gateway 1002 is a transport network layer node, and supports all necessary transport protocols. In this architecture 1000, a UE 104 that is served by a gNB onboard a satellite could access the 5GCN via the inter-satellite link (ISL). In implementations, the gNB onboard different satellites may be connected to the same 5GCN on the ground, and if a satellite hosts more than one gNB, the same satellite radio interface (SRI) may be used to transport all the corresponding NG interface instances.

In aspects of NTN positioning and configuration, a location server is provided additional information to select a positioning method and/or to configure appropriate resources in an NTN. The described techniques include NTN positioning and signaling capabilities between an NG-RAN node (e.g., an NTN entity), a target UE, and a location server (e.g., LMF), with the location server implemented to select an appropriate method for NTN positioning and to configure appropriate resources for wireless communications with the target UE.

For location verification in NTN, some positioning methods may only be applicable for target UEs that are in view (e.g., within coverage range) of a single satellite (e.g., multi-round trip time (RTT)), while some methods may only be applicable when a target UE has at least three satellites in view (e.g., downlink time difference of arrival (DL-TDOA)). In many cases, one NG-RAN node may be communicatively linked to multiple satellites that may or may not provide coverage to the same UE, thus relying on only NG-RAN information may not be sufficient. Therefore, the network location server (e.g., location management function (LMF)) needs the information as to the number of satellites in view (e.g., for coverage) in order to select an appropriate positioning method and to correctly apply the measurement and reporting procedure. Further, in addition to linear polarization in NTN, circular polarization types have been adopted to enhance the link budget. An association of a polarization type with the positioning reference signal (PRS) provides polarization-based configuration and measurements reporting aspects for PRS. However, a polarization type supported by a NG-RAN node and/or by the target UE can also be indicated to the location server.

In one or more implementations, the LMF determines the number of satellites in view (e.g., within coverage range) of the target UE by employing LPP protocol (i.e., by initiating a request message to a target UE indicating to report explicitly or implicitly the number of satellites in view). To further resolve and/or clarify the information provided by the target UE, the LMF may request additional information from the NTN NG-RAN node (e.g., information as to which cell-IDs, TRP-IDs, and/or beam-IDs are served by the NG-RAN node, and which of the cell-IDs, TRP-IDs, and/or beam-IDs correspond to one satellite node in case multiple satellite nodes are connected to a single NG-RAN node). The LMF can then initiate a new request message to NG-RAN to request information about the cell-IDs, TRP-IDs, and/or beam-IDs belonging to that NG-RAN node.

Further, the NG-RAN node and/or the target UE indicates to the location server the support of polarization types that may be used for the transmission and reception of uplink and downlink reference signals for the positioning purposes. The NG-RAN node may be comprised of multiple satellites and/or multiple TRPs that have the same polarization capabilities or different polarization capabilities. In this case, the NG-RAN may indicate separately the polarization support for each of the TRPs.

With reference to signaling the number of satellites in view (e.g., for coverage) of a target UE, in one or more implementations, the LMF determines the number of satellites in view of the target UE by employing LPP protocol (i.e., by initiating a request message to a target UE indicating to report explicitly or implicitly the number of satellites in view. In an implementation, the LPP capability transfer procedure can be used for this purpose, where the LMF explicitly inquires by using a field in the request capability message (e.g., LPP RequestCapabilities message) to indicate the number of satellites in view. The target UE can provide the corresponding information in the response message (i.e., LPP provide capability message) by indicating the number of satellites in view.

In an implementation, this information is part of the provide capability message, even if there is no indication in the request message. For instance, the target UE provides this information in the provide capability message for those positioning methods that are to be used for NTN verification purposes. For example, if multi-RTT is to be used for location estimates in NTN, the location server, in addition to the capability of the target device to support NR Multi-RTT, may request by a field in IE NR-Multi-RTT-RequestCapabilities, the number of satellites in view. The target UE can indicate in the IE NR-Multi-RTT-ProvideCapabilities the number of satellites in view to that target UE, where this indication can be based on a field in the request message or by default (even if there is no request to indicate this information in the request message).

In one or more implementations, the number of satellites in view may relate to the number of cell-IDs, TRP-IDs, or beam-IDs that the target UE detects and/or can perform any one or more RS measurements (e.g., PRS, SSB and so forth on the detected cells, TRPs, or beams) such as for cell-IDs, TRP-IDs, or beam-IDs detected during initial access as verification of the target UE location would be performed just after the initial access. The target UE can list all the cell-IDs and/or TRP-IDs in the capability exchange response message to indicate the number of satellites in view. In an implementation, only the number of cell-IDs, TRP-IDs, and/or beam-IDs are indicated in the response message. In another implementation, the number of cell-IDs, TRP-IDs, and/or beam-IDs and/or the number of satellites in view is indicated. This may be more important, as in NTN, a single satellite may have multiple cell-IDs (e.g., each beam can correspond to a cell).

In some cases, a target UE may be at the intersection area of two or more beams corresponding to different cell-IDs or TRP-IDs that are from a single satellite, thus relying alone on this information may provide false information about the number of satellites in view. In an example, the target UE can resolve this utilizing the ephemeris information that it receives during initial access for timing advance calculation. For instance, the cell-IDs from the same satellite would have the same ephemeris information. The target UE can either indicate only the number of satellites, or along with the cell-IDs, can also indicate which of the cell-IDs belong to the same satellite (e.g., in the case of multiple cell-IDs corresponding to same satellite) based on the ephemeris information it receives (e.g., during initial access).

The NG-RAN node may not have a full view of the number of satellites. In one or more implementations, to further resolve and/or clarify the information provided by the target UE, the LMF can request additional information from the NTN NG-RAN node (e.g., information as to which cell-IDs, TRP-IDs, and/or beam-IDs are served by the NG-RAN node and which of the cell-IDs, TRP-IDs, and/or beam-IDs correspond to one satellite node (in the case of multiple satellite nodes being connected to a single NG-RAN node). The LMF can initiate a new request message to the NG-RAN to inquire for information about the cell-IDs, TRP-IDs, and/or beam-IDs belonging to that NG-RAN node. The NG-RAN node can include a list of the cell-IDs, TRP-IDs, and/or beam-IDs hosted by that NG-RAN node in the response message, and in the case of multiple satellite nodes being served by the same NG-RAN node, a mapping of the cell-IDs, TRP-IDs, and/or beam-IDs to a satellite node may be indicated (i.e., as to which of the cell-IDs, TRP-IDs, and/or beam-IDs belong to one satellite).

In one or more implementations, a satellite ID can be used for identifying each of the satellite nodes that are connected (e.g., communicatively linked) to a NTN NG-RAN node to relate the relationship between cell-IDs and satellite nodes. In an example, the LMF can initiate the TRP information exchange procedure using the NRPPa protocol to allow the LMF to request the NG-RAN node to provide detailed information for TRPs hosted by the NG-RAN node. In response to the TRP information request message initiated by the LMF, the NG-RAN node may include all the information related to all the hosted TRPs, and an additional field may be used by the NG-RAN node to indicate which of the TRPs belong to one satellite. Based on the TRP ID(s) and/or the cell-ID(s) and beam-ID(s) information received from UE (via LPP) and the NG-RAN node (via NRPPa), the LMF can determine whether a single or multiple satellites are providing coverage to the target UE.

In one or more implementations, only the NRPPa protocol is used between the LMF and NG-RAN node(s) to determine the number of satellites that are providing coverage to the target UE, where in addition to TRP-IDs, cell-IDs and/or beam-IDs information, a list of latitudes and longitudes that are being covered by one satellite may also be provided in the response message (e.g., in a capability response message, or in a TRP information IE). Based on the UE cell-ID information and the coverage area of a satellite, the LMF can determine how many satellites may be serving to a UE. In an implementation, if multiple satellites are connected to a NG-RAN node, the coverage area of all satellites may be provided by the NG-RAN node to the LMF.

In one or more implementations, in order to determine the number of satellites in view to the target UE, the LMF, after receiving the location estimate request of the target UE for verification purposes, first initiates the E-CID measurement initiation procedure to report E-CID measurements. The E-CID measurements may correspond to UL and/or DL NR E-CID measurements (e.g., RRM measurements). The NG-RAN node provides the E-CID measurements in the report message, where the E-CID measurement report can contain additional information and/or fields, including in addition to a serving cell-ID, a list of all cell-IDs that are served by the NG-RAN node. Additionally, a beam layout configuration and/or a cell layout configuration (e.g., frequency reuse factor), earth fixed cells, earth moving cells, the number of satellites in view to the target UE for the NG-RAN node (if multiple satellites are served by the NG-RAN node), which may be determined based on SSB or CSI measurements, as well as ephemeris information of the satellites, and/or a list of TRP-IDs.

The E-CID methods can include UL E-CID, DL E-CID, or a combination thereof. In one or more implementations, the LMF can configure to the target UE or the NG-RAN node in the request message to report the number of satellites periodically, semi-persistently, or aperiodic. For example, if a target UE is requested to report the number of satellites in view in the request capability message, a field can be used to indicate that the reporting is only for one time, or is reported with some set interval or periodicity, which may semi-static or dynamic based on an activation or deactivation received by the target-UE. In an implementation, a time window is additionally configured, over which the target UE can report the number of satellites in view with a period or aperiodic interval.

In an implementation, the targe UE or the NG-RAN node is configured by the LMF to report only whenever there is change in the number of satellites in view. In an implementation, the target UE autonomously reports to the LMF whenever there is a change in the number of detected satellites (e.g., in a configured time window). In an implementation, the reporting may be directly linked with the time window of positioning method measurements. For example, if a target UE is configured to perform at least three multi-RTT measurements for a single satellite at different time intervals, a time window corresponding to these measurements can be configured to a UE. In this case, the target UE may automatically report to the LMF if it detects any change in the number of satellites in its view during this time window.

With reference to an indication of support of a polarization type to the location server, the NG-RAN node and/or the target UE indicates to the location server the support of polarization types that may be used for the transmission and reception of uplink and downlink reference signals for positioning purposes. In one or more implementations, the NG-RAN node indicates to the location server with a list of polarization types it supports for the downlink transmission and/or uplink reception. In an example, the NG-RAN node may indicate this to the location server in a TRP information exchange procedure, where it is explicitly indicated to the NG-RAN node in the request message to indicate the polarization types that it supports, or the NG-RAN node may include this information as part of TRP information IE without any indication in the request. For example, the TRP information may have a field to indicate the support of one or multiple polarization types.

In one or more implementations, the NG-RAN node may include multiple satellites and/or multiple TRPs that have the same polarization capabilities or different polarization capabilities. In this case, the NG-RAN node can indicate separately the polarization support for each of the TRPs. For example, polarization support for each TRP and/or satellite is associated with a TRP-ID. Table 5 provides examples of polarization information support in TRP information IE. Note the TRP polarization type, of presence M, and IE type and reference: ENUMERATED (LHCP, RHCP, Linear).

TABLE 5
Examples of polarization information support in TRP information IE.

| | | | IE Type and | Semantics | | Assigned |
|---|---|---|---|---|---|---|
| IE/Group Name | Presence | Range | Reference | Description | Criticality | Criticality |
| TRP ID | M | | 9.2.24 | | — | |
| TRP Information | | 1 . . . | | | — | |
| Type | | <maxnoTRPInfoTypes> | | | | |
| >CHOICE TRP | M | | | | — | |
| Information Item | | | | | | |
| >>NR PCI | M | | INTEGER | NR Physical | — | |
| | | | (0 . . . 1007) | Cell ID | | |
| >>NR CGI | M | | 9.2.9 | | — | |
| >>NR ARFCN | M | | INTEGER | | — | |
| | | | (0 . . . 3279165) | | | |
| >>PRS | M | | 9.2.44 | | — | |
| Configuration | | | | | | |
| >>SSB | M | | 9.2.54 | | — | |
| Information | | | | | | |
| >>SFN | M | | Relative Time | | — | |
| Initialization | | | 1900 | | | |
| Time | | | 9.2.36 | | | |
| >>Spatial | M | | 9.2.45 | | — | |
| Direction | | | | | | |
| Information | | | | | | |
| >>Geographical | M | | 9.2.46 | | — | |
| Coordinates | | | | | | |
| >>TRP type | M | | ENUMERATED | TS 38.305 [18] | YES | reject |
| | | | (prs-only-tp, | | | |
| | | | srs-only-rp, tp, | | | |
| | | | rp, trp . . . ) | | | |
| >>TRP | M | | ENUMERATED | | | |
| Polarization Type | | | (LHCP, RHCP, | | | |
| | | | Linear) | | | |
| >>On-demand | M | | 9.2.65 | | YES | reject |
| PRS TRP | | | | | | |
| Information | | | | | | |
| >>TRP Tx TEG | M | | 9.2.79 | | YES | reject |
| Association | | | | | | |
| >>TRP Beam | M | | 9.2.82 | | YES | reject |
| Antenna | | | | | | |
| Information | | | | | | |

In one or more implementations, polarization information may be part of PRS configuration IE, where the NG-RAN node indicates which polarization types are supported (or to be used) with PRS resource set IDs or PRS-IDs. In an implementation, when the polarization type is indicated as part of the TRP information IE, the LMF is implemented so that any one the indicated polarization types may be used with PRS resources. Depending on the UE polarization capability, one of the polarization types can be used for PRS and indicated as part of the assistance data configuration.

In one or more implementations, the UE can indicate its polarization capabilities in the provide capability message to indicate to the location server about the types of polarization it supports. For example, if a UE receives a capability message request from the location server for its capabilities to support multi-RTT method (e.g., using IE NR-Multi-RTT-RequestCapabilities), the UE can indicate its capability to support one or multiple polarization types in the provide capability message (e.g., in IE NR-Multi-RTT-ProvideCapabilities). The UE provides the location server with the polarization types for which of the TRPs. For instance, if the UE supports two circular polarization types, it may indicate by a field in the IE as SupportOfPolarization ENUMERATED {LHCP,RHCP} OPTIONAL.

In an implementation, the target UE separately indicates its capability to transmit SRS with a polarization type. There may be cases where a set of polarization types are used for downlink, while a different set of polarization types are used for uplink. Therefore, in one example, a field in IE NR-UL-SRS-Capability, e.g., SRS-Pol-Type, can be used to indicate the SRS transmission polarization capability.

In one or more implementations, the NG-RAN node indicates to the location server the types of polarization that are supported by the UE. This can be part of the information exchange messages between the location server and the NG-RAN node, where a UE polarization support parameter is used. The information about a polarization type support capability may already be known to the NG-RAN nodes, for example, as indicated in a UE capabilities information exchange between a UE and a gNB, or indicated during initial access by an implicit or explicit indication. In an implementation, the polarization type indication by the NG-RAN node is specific to a reference signal (i.e., the reference signal supports which types of polarization for a UE).

In one or more implementations, a separate indication is included in the response message by the NG-RAN node and/or the target UE to indicate which polarization type is supported for which reference signal. For instance, a set of polarization types may only be supported by the NG-RAN node or the target UE for the positioning reference signals, whereas another set of polarization types may be supported by the NG-RAN node or the target UE for sounding reference signals. In this case, an additional indication may be used to indicate to the LMF the type of polarization support for the respective reference signal. In an implementation, if there is no additional information, the LMF may determine that the indicated polarization types are supported by the NG-RAN node or the target UE for all reference signals.

In an implementation, there is no explicit indication about the polarization type support for a reference signal type, but rather an implicit indication may be used for this purpose. For example, if support of polarization types is indicated in the TRP information IE as shown in Table 5, the LMF can determine that the indicated polarization types are supported for all reference signals (e.g., for both transmission and reception) by the NG-RAN node. Alternatively, if indicated in the reference signal configuration, the LMF determines that the indicated polarization support is specific to that reference signal (e.g., if indicated in PRS configuration IE, then the indicated polarization support may be specific to PRS for downlink). Similarly, if indicated in the NR-UL-SRS-Capability IE by the target UE, then the LMF may understand the indicated polarization types may be used for uplink SRS transmissions for the target UE.

With reference to the configuration and reporting aspects for SRS with polarization in positioning, one or multiple polarization types (e.g., RHCP and LHCP) are associated with different SRS signals to be used for uplink transmission and reception for positioning purposes, where this association may either be configured by the location server to the NG-RAN node and the target UE, or by the NG-RAN node to the target UE. In one or more implementations, the NG-RAN node (or gNB) determines the polarization type to be used for SRS transmission and configures the association of the polarization type with SRS resources using RRC signaling. The NG-RAN node may indicate to the location server the type of polarization that is configured for uplink SRS.

In implementations, the location server configures the polarization types to be used for SRS transmission and reception (i.e., to both the target UE and the NG-RAN node) which may be based on indicated NG-RAN node polarization support (e.g., by information exchanged via messaging using NRPPa) and indicated UE capabilities (e.g., UE capability information exchanged using LPP). In an implementation, the location server indicates a polarization type for SRS transmission to the NG-RAN node to configure the target UE.

In one or more implementations, the UE is configured by the NG-RAN node or location server to report a polarization type that is used for UL-SRS transmission for a positioning method (e.g., multi-RTT). The UE would indicate this by a field in the location estimate measurement report of that method, showing which polarization type is used for UL-SRS. In an implementation, the target UE would indicate the UL-SRS polarization type in the measurement report with or without any indication by location server or NG-RAN node. In one or more implementations, the NG-RAN node can indicate to the location server the polarization type that is used for UL-SRS reception for a positioning method and may include it as part of measurement report messages. This indication can either be a part of an indication in the request message, or the NG-RAN node can include it as part of the report message for a positioning method that utilizes SRS. For example, in the multi-RTT measurement report procedure between the NG-RAN node and the location server, the NG-RAN node can include a field to indicate the polarization used for UL-SRS reception along with gNB Rx-Tx difference.

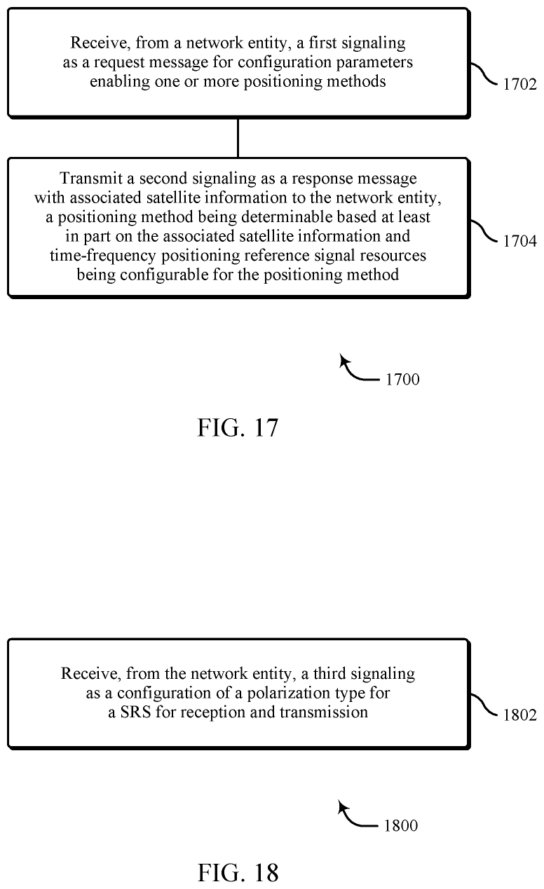

FIG. 11 illustrates an example of a block diagram 1100 of a device 1102 that supports NTN positioning and configuration in accordance with aspects of the present disclosure. The device 1102 may be an example of a network entity 102 (e.g., a LMF, an NTN entity) as described herein. The device 1102 may support wireless communication with one or more network entities 102, UEs 104, or any combination thereof. The device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1104 and the memory 1106 coupled with the processor 1104 may be configured to perform one or more of the functions described herein (e.g., executing, by the processor 1104, instructions stored in the memory 1106).

For example, the processor 1104 may support wireless communication at the device 1102 (e.g., LMF communicates with a NG-RAN node) in accordance with examples as disclosed herein. The processor 1104 may be configured as or otherwise support a means for transmitting, to an NTN entity, a first signaling as a request message for configuration parameters enabling one or more positioning methods; receiving a second signaling as a response message with associated satellite information from the NTN entity; determining a positioning method based at least in part on the associated satellite information received in the response message; and configuring time-frequency positioning reference signal resources for the positioning method based on the associated satellite information.

Additionally, the processor 1104 may be configured as or otherwise support any one or combination of the request message includes a request for a number of satellites communicatively linked to the NTN entity. The configuration parameters include a list of at least one of cell-IDs, TRP-IDs, or beam-IDs associated with each of the satellites communicatively linked to the NTN entity. The response message of the associated satellite information includes the number of the satellites communicatively linked to the NTN entity and the list of at least one of the cell-IDs, the TRP-IDs, or the beam-IDs associated with each of the satellites. The response message of the associated satellite information includes a mapping of at least one of cell-IDs, TRP-IDs, or beam-IDs for each satellite communicatively linked to the NTN entity. The response message includes an E-CID measurement report message. The E-CID measurement report includes the configuration parameters for at least one of a transmission beam and cell layout configuration, earth fixed cells, earth moving cells, a number of satellites communicatively linked to the NTN entity and within coverage range of a target UE, ephemeris information of the satellites, a list of TRP-IDs and relation to each of the satellites, or a list of cell-IDs and the relation to each of the satellites. The response message includes an indication of a polarization type that is supported by the NTN entity. The response message includes one or more polarization types supported by each of one or more TRPs hosted by the NTN entity. The method further comprising transmitting, to the NTN entity, a third signaling as a configuration of a polarization type for a SRS for reception and transmission.

Additionally, or alternatively, the device 1102, in accordance with examples as disclosed herein, may include a processor and a memory coupled with the processor, the processor configured to cause the apparatus to: transmit, to an NTN entity, a first signaling as a request message for configuration parameters enabling one or more positioning methods; receive a second signaling as a response message with associated satellite information from the NTN entity; determine a positioning method based at least in part on the associated satellite information received in the response message; and configure time-frequency positioning reference signal resources for the positioning method based on the associated satellite information.

Additionally, the wireless communication at the device 1102 may include any one or combination of the request message includes a request for a number of satellites communicatively linked to the NTN entity. The configuration parameters include a list of at least one of cell-IDs, TRP-IDs, or beam-IDs associated with each of the satellites communicatively linked to the NTN entity. The response message of the associated satellite information includes the number of the satellites communicatively linked to the NTN entity and the list of at least one of the cell-IDs, the TRP-IDs, or the beam-IDs associated with each of the satellites. The response message of the associated satellite information includes a mapping of at least one of cell-IDs, TRP-IDs, or beam-IDs for each satellite communicatively linked to the NTN entity. The response message includes an E-CID measurement report message. The E-CID measurement report includes the configuration parameters for at least one of a transmission beam and cell layout configuration, earth fixed cells, earth moving cells, a number of satellites communicatively linked to the NTN entity and within coverage range of a target UE, ephemeris information of the satellites, a list of TRP-IDs and relation to each of the satellites, or a list of cell-IDs and the relation to each of the satellites. The response message includes an indication of a polarization type that is supported by the NTN entity. The response message includes one or more polarization types supported by each of one or more TRPs hosted by the NTN entity. The processor is configured to cause the apparatus to transmit, to the NTN entity, a third signaling as a configuration of a polarization type for a SRS for reception and transmission.

For example, the processor 1104 may support wireless communication at the device 1102 (e.g., LMF communicates with a UE) in accordance with examples as disclosed herein. The processor 1104 may be configured as or otherwise support a means for transmitting, to a UE, a first signaling as a request message for configuration parameters enabling one or more positioning methods; receiving a second signaling as a response message with associated satellite information from the UE; determining a positioning method based at least in part on the associated satellite information received in the response message; and configuring time-frequency positioning reference signal resources for the positioning method based on the associated satellite information.

Additionally, the processor 1104 may be configured as or otherwise support any one or combination of the request message includes a request for a number of satellites within coverage range of the UE. The request message is a LPP provide capability message. The response message includes an indication of a number of satellites within coverage range of the UE. The number of the satellites within coverage range of the UE are associated with at least one of detected cell-IDs, TRP-IDs, or beam-IDs. The method further comprising receiving a third signaling as an indication to report a number of satellites within coverage range of the UE in at least one of a periodic manner, a semi-persistent manner, or an aperiodic manner. The method further comprising receiving a third signaling as a new response message generated by the UE responsive to a change in a number of satellites within coverage range of the UE. The response message includes an indication of a polarization type that is supported by the UE. The response message includes one or more polarization types supported for downlink reference signals and uplink reference signals.

Additionally, or alternatively, the device 1102, in accordance with examples as disclosed herein, may include a processor and a memory coupled with the processor, the processor configured to cause the apparatus to: transmit, to a UE, a first signaling as a request message for configuration parameters enabling one or more positioning methods; receive a second signaling as a response message with associated satellite information from the UE; determine a positioning method based at least in part on the associated satellite information received in the response message; and configure time-frequency positioning reference signal resources for the positioning method based on the associated satellite information.

Additionally, the wireless communication at the device 1102 may include any one or combination of the request message includes a request for a number of satellites within coverage range of the UE. The request message is a LPP provide capability message. The response message includes an indication of a number of satellites within coverage range of the UE. The number of the satellites within coverage range of the UE are associated with at least one of detected cell-IDs, TRP-IDs, or beam-IDs. The processor is configured to cause the apparatus to receive a third signaling as an indication to report a number of satellites within coverage range of the UE in at least one of a periodic manner, a semi-persistent manner, or an aperiodic manner. The processor is configured to cause the apparatus to receive a third signaling as a new response message generated by the UE responsive to a change in a number of satellites within coverage range of the UE. The response message includes an indication of a polarization type that is supported by the UE. The response message includes one or more polarization types supported for downlink reference signals and uplink reference signals.

For example, the processor 1104 may support wireless communication at the device 1102 (e.g., NTN entity, NG-RAN node) in accordance with examples as disclosed herein. The processor 1104 may be configured as or otherwise support a means for receiving, from a network entity, a first signaling as a request message for configuration parameters enabling one or more positioning methods; and transmitting a second signaling as a response message with associated satellite information to the network entity, a positioning method being determinable based at least in part on the associated satellite information and time-frequency positioning reference signal resources being configurable for the positioning method.

Additionally, the processor 1104 may be configured as or otherwise support any one or combination of the request message includes a request for a number of satellites communicatively linked to an NTN entity. The configuration parameters include a list of at least one of cell-IDs, TRP IDs, or beam-IDs associated with each of the satellites communicatively linked to the NTN entity. The response message of the associated satellite information includes the number of the satellites communicatively linked and the list of at least one of the cell-IDs, the TRP-IDs, or the beam-IDs associated with each of the satellites. The response message of the associated satellite information includes a mapping of at least one of cell-IDs, TRP IDs, or beam-IDs for each satellite communicatively linked to an NTN entity. The response message includes an E-CID measurement report message. The E-CID measurement report includes the configuration parameters for at least one of a transmission beam and cell layout configuration, earth fixed cells, earth moving cells, a number of satellites communicatively linked to an NTN entity and within coverage range of a target UE, ephemeris information of the satellites, a list of TRP-IDs and relation to each of the satellites, or a list of cell-IDs and the relation to each of the satellites. The response message includes an indication of a polarization type that is supported by an NTN entity. The response message includes one or more polarization types supported by each of one or more TRPs hosted by the NTN entity. The method further comprising receiving, from the network entity, a third signaling as a configuration of a polarization type for a SRS for reception and transmission.

Additionally, or alternatively, the device 1102, in accordance with examples as disclosed herein, may include a processor and a memory coupled with the processor, the processor configured to cause the apparatus to: receive, from a network entity, a first signaling as a request message for configuration parameters enabling one or more positioning methods; and transmit a second signaling as a response message with associated satellite information to the network entity, a positioning method being determinable based at least in part on the associated satellite information and time-frequency positioning reference signal resources being configurable for the positioning method.

Additionally, the wireless communication at the device 1102 may include any one or combination of the request message includes a request for a number of satellites communicatively linked to the apparatus. The configuration parameters include a list of at least one of cell-IDs, TRP-IDs, or beam-IDs associated with each of the satellites communicatively linked to the apparatus. The response message of the associated satellite information includes the number of the satellites communicatively linked to the apparatus and the list of at least one of the cell-IDs, the TRP-IDs, or the beam-IDs associated with each of the satellites. The response message of the associated satellite information includes a mapping of at least one of cell-IDs, TRP-IDs, or beam-IDs for each satellite communicatively linked to the apparatus. The response message includes an E-CID measurement report message. The E-CID measurement report includes the configuration parameters for at least one of a transmission beam and cell layout configuration, earth fixed cells, earth moving cells, a number of satellites communicatively linked to the apparatus and within coverage range of a target UE, ephemeris information of the satellites, a list of TRP-IDs and relation to each of the satellites, or a list of cell-IDs and the relation to each of the satellites. The response message includes an indication of a polarization type that is supported by the apparatus. The response message includes one or more polarization types supported by each of one or more TRPs hosted by the apparatus. The processor is configured to cause the apparatus to receive, from the network entity, a third signaling as a configuration of a polarization type for a SRS for reception and transmission.

The processor 1104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the device 1102 to perform various functions of the present disclosure.

The memory 1106 may include random access memory (RAM) and read-only memory (ROM). The memory 1106 may store computer-readable, computer-executable code including instructions that, when executed by the processor 1104 cause the device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic I/O system (BIOS) which may control basic hardware or software operation such as the interaction with peripheral components or devices.

The I/O controller 1110 may manage input and output signals for the device 1102. The I/O controller 1110 may also manage peripherals not integrated into the device M02. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor 1104. In some implementations, a user may interact with the device 1102 via the I/O controller 1110 or via hardware components controlled by the I/O controller 1110.

In some implementations, the device 1102 may include a single antenna 1112. However, in some other implementations, the device 1102 may have more than one antenna 1112 (i.e., multiple antennas), including multiple antenna panels or antenna arrays, which may be capable of concurrently transmitting or receiving multiple wireless transmissions. The transceiver 1108 may communicate bi-directionally, via the one or more antennas 1112, wired, or wireless links as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112.

FIG. 12 illustrates an example of a block diagram 1200 of a device 1202 that supports NTN positioning and configuration in accordance with aspects of the present disclosure. The device 1202 may be an example of a UE 104 as described herein. The device 1202 may support wireless communication with one or more network entities 102, UEs 104, or any combination thereof. The device 1202 may include components for bi-directional communications including components for transmitting and receiving communications, such as a processor 1204, a memory 1206, a transceiver 1208, and an I/O controller 1210. These components may be in electronic communication or otherwise coupled (e.g., operatively, communicatively, functionally, electronically, electrically) via one or more interfaces (e.g., buses).

The processor 1204, the memory 1206, the transceiver 1208, or various combinations thereof or various components thereof may be examples of means for performing various aspects of the present disclosure as described herein. For example, the processor 1204, the memory 1206, the transceiver 1208, or various combinations or components thereof may support a method for performing one or more of the operations described herein.

In some implementations, the processor 1204, the memory 1206, the transceiver 1208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1204 and the memory 1206 coupled with the processor 1204 may be configured to perform one or more of the functions described herein (e.g., executing, by the processor 1204, instructions stored in the memory 1206).

For example, the processor 1204 may support wireless communication at the device 1202 in accordance with examples as disclosed herein. The processor 1204 may be configured as or otherwise support a means for receiving, from a network entity, a first signaling as a request message for configuration parameters enabling one or more positioning methods, the request message including a request for a number of satellites within coverage range; and transmitting a second signaling as a response message with associated satellite information to the network entity, a positioning method being determinable based at least in part on the associated satellite information and time-frequency positioning reference signal resources being configurable for the positioning method.

Additionally, the processor 1204 may be configured as or otherwise support any one or combination of the request message is a LPP provide capability message. The response message includes an indication of the number of the satellites within coverage range. The number of the satellites within coverage range are associated with at least one of detected cell-IDs, TRP-IDs, or beam-IDs. The method further comprising transmitting a third signaling as a report of the number of the satellites within coverage range in at least one of a periodic manner, a semi-persistent manner, or an aperiodic manner. The method further comprising transmitting a third signaling as a new response message generated responsive to a change in the number of the satellites within coverage range. The response message includes an indication of a polarization type that is supported by a UE. The response message includes one or more polarization types supported for downlink reference signals and uplink reference signals.

Additionally, or alternatively, the device 1202, in accordance with examples as disclosed herein, may include a processor and a memory coupled with the processor, the processor configured to cause the apparatus to: receive, from a network entity, a first signaling as a request message for configuration parameters enabling one or more positioning methods, the request message including a request for a number of satellites within coverage range of the apparatus; and transmit a second signaling as a response message with associated satellite information to the network entity, a positioning method being determinable based at least in part on the associated satellite information and time-frequency positioning reference signal resources being configurable for the positioning method.

Additionally, the wireless communication at the device 1202 may include any one or combination of the request message is a LPP provide capability message. The response message includes an indication of the number of the satellites within coverage range of the apparatus. The number of the satellites within coverage range of the apparatus are associated with at least one of detected cell-IDs, TRP-IDs, or beam-IDs. The processor is configured to cause the apparatus to transmit a third signaling as a report of the number of the satellites within coverage range of the apparatus in at least one of a periodic manner, a semi-persistent manner, or an aperiodic manner. The processor is configured to cause the apparatus to transmit a third signaling as a new response message generated by the apparatus responsive to a change in the number of the satellites within coverage range of the apparatus. The response message includes an indication of a polarization type that is supported by the apparatus. The response message includes one or more polarization types supported for downlink reference signals and uplink reference signals.

The processor 1204 of the device 1202, such as a UE 104, may support wireless communication in accordance with examples as disclosed herein. The processor 1204 includes at least one controller coupled with at least one memory, and is configured to or operable to cause the processor to receive, from a network entity, a first signaling as a request message for configuration parameters enabling one or more positioning methods, the request message including a request for a number of satellites within coverage range; and transmit a second signaling as a response message with associated satellite information to the network entity, a positioning method being determinable based at least in part on the associated satellite information and time-frequency positioning reference signal resources being configurable for the positioning method.

The processor 1204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1204 may be configured to operate a memory array using a memory controller. In some other implementations, a memory controller may be integrated into the processor 1204. The processor 1204 may be configured to execute computer-readable instructions stored in a memory (e.g., the memory 1206) to cause the device 1202 to perform various functions of the present disclosure.

The memory 1206 may include random access memory (RAM) and read-only memory (ROM). The memory 1206 may store computer-readable, computer-executable code including instructions that, when executed by the processor 1204 cause the device 1202 to perform various functions described herein. The code may be stored in a non-transitory computer-readable medium such as system memory or another type of memory. In some implementations, the code may not be directly executable by the processor 1204 but may cause a computer (e.g., when compiled and executed) to perform functions described herein. In some implementations, the memory 1206 may include, among other things, a basic I/O system (BIOS) which may control basic hardware or software operation such as the interaction with peripheral components or devices.

The I/O controller 1210 may manage input and output signals for the device 1202. The I/O controller 1210 may also manage peripherals not integrated into the device 1202. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. In some implementations, the I/O controller 1210 may be implemented as part of a processor, such as the processor 1204. In some implementations, a user may interact with the device 1202 via the I/O controller 1210 or via hardware components controlled by the I/O controller 1210.

In some implementations, the device 1202 may include a single antenna 1212. However, in some other implementations, the device 1202 may have more than one antenna 1212 (i.e., multiple antennas), including multiple antenna panels or antenna arrays, which may be capable of concurrently transmitting or receiving multiple wireless transmissions. The transceiver 1208 may communicate bi-directionally, via the one or more antennas 1212, wired, or wireless links as described herein. For example, the transceiver 1208 may represent a wireless transceiver and may communicate bi-directionally with another wireless transceiver. The transceiver 1208 may also include a modem to modulate the packets, to provide the modulated packets to one or more antennas 1212 for transmission, and to demodulate packets received from the one or more antennas 1212.

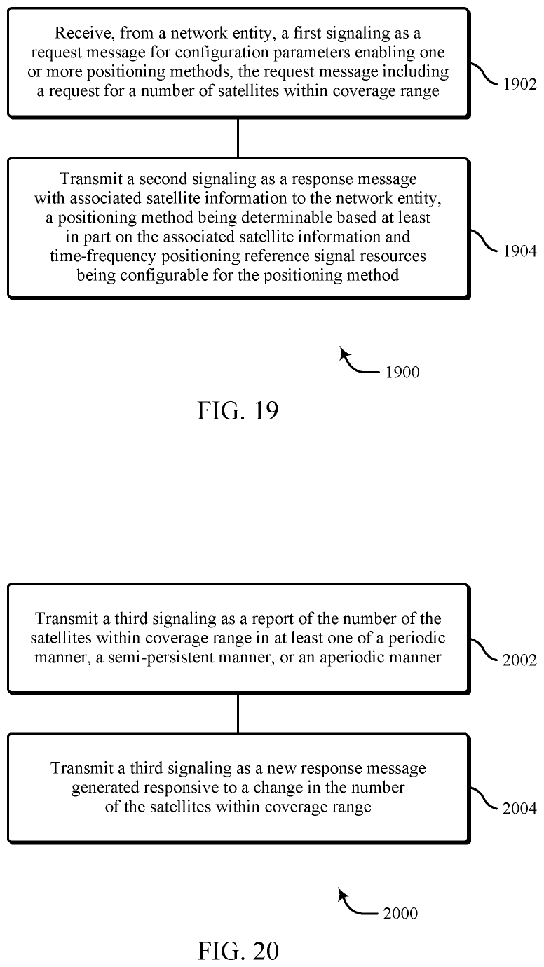

FIG. 13 illustrates a flowchart of a method 1300 that supports NTN positioning and configuration in accordance with aspects of the present disclosure. The operations of the method 1300 may be implemented by a device or its components as described herein. For example, the operations of the method 1300 may be performed by a network entity 102 (e.g., LMF) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1302, the method may include transmitting, to an NTN entity, a first signaling as a request message for configuration parameters enabling one or more positioning methods. The operations of 1302 may be performed in accordance with examples as described herein. In some implementations, aspects of the operations of 1302 may be performed by a device as described with reference to FIG. 1.

At 1304, the method may include receiving a second signaling as a response message with associated satellite information from the NTN entity. The operations of 1304 may be performed in accordance with examples as described herein. In some implementations, aspects of the operations of 1304 may be performed by a device as described with reference to FIG. 1.

At 1306, the method may include determining a positioning method based at least in part on the associated satellite information received in the response message. The operations of 1306 may be performed in accordance with examples as described herein. In some implementations, aspects of the operations of 1306 may be performed by a device as described with reference to FIG. 1.

At 1308, the method may include configuring time-frequency positioning reference signal resources for the positioning method based on the associated satellite information. The operations of 1308 may be performed in accordance with examples as described herein. In some implementations, aspects of the operations of 1308 may be performed by a device as described with reference to FIG. 1.

FIG. 14 illustrates a flowchart of a method 1400 that supports NTN positioning and configuration in accordance with aspects of the present disclosure. The operations of the method 1400 may be implemented by a device or its components as described herein. For example, the operations of the method 1400 may be performed by a network entity 102 (e.g., LMF) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1402, the method may include transmitting, to the NTN entity, a third signaling as a configuration of a polarization type for a SRS for reception and transmission. The operations of 1402 may be performed in accordance with examples as described herein. In some implementations, aspects of the operations of 1402 may be performed by a device as described with reference to FIG. 1.

FIG. 15 illustrates a flowchart of a method 1500 that supports NTN positioning and configuration in accordance with aspects of the present disclosure. The operations of the method 1500 may be implemented by a device or its components as described herein. For example, the operations of the method 1500 may be performed by a network entity 102 (e.g., LMF) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1502, the method may include transmitting, to a UE, a first signaling as a request message for configuration parameters enabling one or more positioning methods. The operations of 1502 may be performed in accordance with examples as described herein. In some implementations, aspects of the operations of 1502 may be performed by a device as described with reference to FIG. 1.

At 1504, the method may include receiving a second signaling as a response message with associated satellite information from the UE. The operations of 1504 may be performed in accordance with examples as described herein. In some implementations, aspects of the operations of 1504 may be performed by a device as described with reference to FIG. 1.

At 1506, the method may include determining a positioning method based at least in part on the associated satellite information received in the response message. The operations of 1506 may be performed in accordance with examples as described herein. In some implementations, aspects of the operations of 1506 may be performed by a device as described with reference to FIG. 1.

At 1508, the method may include configuring time-frequency positioning reference signal resources for the positioning method based on the associated satellite information. The operations of 1508 may be performed in accordance with examples as described herein. In some implementations, aspects of the operations of 1508 may be performed by a device as described with reference to FIG. 1.

FIG. 16 illustrates a flowchart of a method 1600 that supports NTN positioning and configuration in accordance with aspects of the present disclosure. The operations of the method 1600 may be implemented by a device or its components as described herein. For example, the operations of the method 1600 may be performed by a network entity 102 (e.g., LMF) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1602, the method may include receiving a third signaling as an indication to report a number of satellites within coverage range of the UE in at least one of a periodic manner, a semi-persistent manner, or an aperiodic manner. The operations of 1602 may be performed in accordance with examples as described herein. In some implementations, aspects of the operations of 1602 may be performed by a device as described with reference to FIG. 1.

At 1604, the method may include receiving a third signaling as a new response message generated by the UE responsive to a change in a number of satellites within coverage range of the UE. The operations of 1604 may be performed in accordance with examples as described herein. In some implementations, aspects of the operations of 1604 may be performed by a device as described with reference to FIG. 1.

FIG. 17 illustrates a flowchart of a method 1700 that supports NTN positioning and configuration in accordance with aspects of the present disclosure. The operations of the method 1700 may be implemented by a device or its components as described herein. For example, the operations of the method 1700 may be performed by a network entity 102 (e.g., NG-RAN node) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1702, the method may include receiving, from a network entity, a first signaling as a request message for configuration parameters enabling one or more positioning methods. The operations of 1702 may be performed in accordance with examples as described herein. In some implementations, aspects of the operations of 1702 may be performed by a device as described with reference to FIG. 1.

At 1704, the method may include transmitting a second signaling as a response message with associated satellite information to the network entity, a positioning method being determinable based at least in part on the associated satellite information and time-frequency positioning reference signal resources being configurable for the positioning method. The operations of 1704 may be performed in accordance with examples as described herein. In some implementations, aspects of the operations of 1704 may be performed by a device as described with reference to FIG. 1.

FIG. 18 illustrates a flowchart of a method 1800 that supports NTN positioning and configuration in accordance with aspects of the present disclosure. The operations of the method 1800 may be implemented by a device or its components as described herein. For example, the operations of the method 1800 may be performed by a network entity 102 (e.g., NG-RAN node) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1802, the method may include receiving, from the network entity, a third signaling as a configuration of a polarization type for a SRS for reception and transmission. The operations of 1802 may be performed in accordance with examples as described herein. In some implementations, aspects of the operations of 1802 may be performed by a device as described with reference to FIG. 1.

FIG. 19 illustrates a flowchart of a method 1900 that supports NTN positioning and configuration in accordance with aspects of the present disclosure. The operations of the method 1900 may be implemented by a device or its components as described herein. For example, the operations of the method 1900 may be performed by a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1902, the method may include receiving, from a network entity, a first signaling as a request message for configuration parameters enabling one or more positioning methods, the request message including a request for a number of satellites within coverage range. The operations of 1902 may be performed in accordance with examples as described herein. In some implementations, aspects of the operations of 1902 may be performed by a device as described with reference to FIG. 1.

At 1904, the method may include transmitting a second signaling as a response message with associated satellite information to the network entity, a positioning method being determinable based at least in part on the associated satellite information and time-frequency positioning reference signal resources being configurable for the positioning method. The operations of 1904 may be performed in accordance with examples as described herein. In some implementations, aspects of the operations of 1904 may be performed by a device as described with reference to FIG. 1.

FIG. 20 illustrates a flowchart of a method 2000 that supports NTN positioning and configuration in accordance with aspects of the present disclosure. The operations of the method 2000 may be implemented by a device or its components as described herein. For example, the operations of the method 2000 may be performed by a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 2002, the method may include transmitting a third signaling as a report of the number of the satellites within coverage range in at least one of a periodic manner, a semi-persistent manner, or an aperiodic manner. The operations of 2002 may be performed in accordance with examples as described herein. In some implementations, aspects of the operations of 2002 may be performed by a device as described with reference to FIG. 1.

At 2004, the method may include transmitting a third signaling as a new response message generated responsive to a change in the number of the satellites within coverage range. The operations of 2004 may be performed in accordance with examples as described herein. In some implementations, aspects of the operations of 2004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity (NE) for wireless communication, comprising:
at least one memory; and
at least one processor coupled with the at least one memory and operable to cause the NE to:
transmit a request message for configuration parameters enabling one or more positioning methods;
receive a response message with associated satellite information of a non-terrestrial network (NTN) entity;
determine a positioning method based at least in part on the associated satellite information received in the response message; and
configure time-frequency positioning reference signal resources for the positioning method based on the associated satellite information.

2. The NE of claim 1, wherein the request message includes a request for a number of satellites communicatively linked to the NTN entity.

3. The NE of claim 2, wherein the response message of the associated satellite information includes the number of the satellites communicatively linked to the NTN entity, and wherein the configuration parameters include a list of at least one of cell-identities (IDs), transmission-reception point (TRP)-IDs, or beam-IDs associated with each of the satellites communicatively linked to the NTN entity.

4. The NE of claim 1, wherein the response message of the associated satellite information includes a mapping of at least one of cell-identities (IDs), transmission-reception point (TRP)-IDs, or beam-IDs for each satellite communicatively linked to the NTN entity.

5. The NE of claim 1, wherein the response message includes an enhanced cell-identity (ID) (E-CID) measurement report message, and wherein the E-CID measurement report includes the configuration parameters for at least one of a transmission beam and cell layout configuration, earth fixed cells, earth moving cells, a number of satellites communicatively linked to the NTN entity and within coverage range of a target user equipment (UE), ephemeris information of the satellites, a list of transmission-reception point (TRP)-IDs and relation to each of the satellites, or a list of cell-IDs and the relation to each of the satellites.

6. The NE of claim 1, wherein the response message includes an indication of a polarization type that is supported by the NTN entity, and wherein the response message includes one or more polarization types supported by each of one or more transmission-reception points (TRPs) hosted by the NTN entity.

7. The NE of claim 1, wherein the at least one processor is operable to cause the NE to transmit a configuration of a polarization type for a sounding reference signal (SRS) for reception and transmission.

8. A network entity (NE) for wireless communication, comprising:
at least one memory; and
at least one processor coupled with the at least one memory and operable to cause the NE to:
transmit a request message for configuration parameters enabling one or more positioning methods;
receive a response message with associated satellite information from a user equipment (UE);
determine a positioning method based at least in part on the associated satellite information received in the response message; and
configure time-frequency positioning reference signal resources for the positioning method based on the associated satellite information.

9. The NE of claim 8, wherein the request message includes a request for a number of satellites within coverage range of the UE, and wherein the response message includes an indication of the number of satellites within the coverage range of the UE.

10. The NE of claim 9, wherein the request message is a long-term evolution (LTE) positioning protocol (LPP) provide capability message.

11. The NE of claim 9, wherein the number of the satellites within the coverage range of the UE are associated with at least one of detected cell-identities (IDs), transmission-reception point (TRP)-IDs, or beam-IDs.

12. The NE of claim 8, wherein the at least one processor is operable to cause the NE to receive an indication to report a number of satellites within coverage range of the UE in at least one of a periodic manner, a semi-persistent manner, or an aperiodic manner.

13. A user equipment (UE) for wireless communication, comprising:
at least one memory; and
at least one processor coupled with the at least one memory and operable to cause the UE to:
receive a request message for configuration parameters enabling one or more positioning methods, the request message including a request for a number of satellites within coverage range of the UE; and
transmit a response message with associated satellite information, wherein a positioning method is determinable based at least in part on the associated satellite information and time-frequency positioning reference signal resources being configurable for the positioning method.

14. The UE of claim 13, wherein the request message is a long-term evolution (LTE) positioning protocol (LPP) provide capability message, and wherein the response message includes an indication of the number of the satellites within the coverage range of the UE.

15. The UE of claim 14, wherein the number of the satellites within the coverage range of the UE are associated with at least one of detected cell-identities (IDs), transmission-reception point (TRP)-IDs, or beam-IDs.

16. The UE of claim 13, wherein the at least one processor is operable to cause the UE to transmit a report of the number of the satellites within the coverage range of the UE in at least one of a periodic manner, a semi-persistent manner, or an aperiodic manner.

17. The UE of claim 13, wherein the at least one processor is operable to cause the UE to transmit a new response message generated by the UE responsive to a change in the number of the satellites within the coverage range of the UE.

18. The UE of claim 13, wherein the response message includes an indication of a polarization type that is supported by the UE.

19. The UE of claim 18, wherein the response message includes one or more polarization types supported for downlink reference signals and uplink reference signals.

20. (canceled)

21. A method performed by a user equipment (UE), the method comprising:
receiving a request message for configuration parameters enabling one or more positioning methods, the request message including a request for a number of satellites within coverage range of the UE; and
transmitting a response message with associated satellite information, wherein a positioning method is determinable based at least in part on the associated satellite information and time-frequency positioning reference signal resources being configurable for the positioning method.
